(19) United States
(12) Patent Application Publication
(10) Pub. No.: US 2018/0134942 A1
(43) Pub. Date: May 17, 2018

(54) WATER SOLUBLE EPOXY RESIN SYSTEM WITH ENHANCED ABSORPTION AT HIGHER TEMPERATURES

(71) Applicant: HALLIBURTON ENERGY SERVICES INC., Houston, TX (US)

(72) Inventors: Sushant Dattaram Wadekar, Pune (IN); Sumit Shivshankar Konale, Pune (IN)

(21) Appl. No.: 15/580,158

(22) PCT Filed: Sep. 21, 2015
(86) PCT No.: PCT/US2015/051230

§ 371 Date: Dec. 6, 2017

(51) Int. Cl. C09K 8/575; C08J 3/05; C08G 59/22; E21B 41/00

(52) U.S. Cl. CPC C09K 8/5755; C08J 3/05; C08J 2363/00; E21B 41/00; C08G 59/22

(57) ABSTRACT

Methods and fluids for particulate consolidation using an aqueous carrier solution are described. The fluids comprise an aqueous based treatment fluid containing a water soluble epoxy. The solution is suitable for use as a treatment fluid in particulate consolidation processes in a subterranean formation and is homogenous at temperatures of about 70° F. (21° C.).

### TECHNICAL FIELD

The present invention relates generally to sand consolidation and more specifically to a water-soluble epoxy resin system with enhanced adsorption at higher temperatures for use in particulate consolidation.

### BACKGROUND

Hydrocarbon harvesting often produces significant amounts of small particulate material and/or particles. The majority of these particles come from unconsolidated or loosely consolidated subterranean formations (“formation sand”) that are swept into the well fluids as they flow from the reservoir to the wells. Although formation sand is a natural by-product of the harvesting process, these particulates are undesirable for several reasons. First, a significant portion of the particles drop out of the well fluids and settle at the bottom of the wellbore. As these particles build up to the producing interval, they can reduce the hydrocarbon productivity of the wellbore. Second, particles that remain in the well fluids can clog equipment and therefore pose a serious risk to the operation of topside equipment. Finally, particulate migration from the formation into the wellbore leaves voids in the formation that ultimately may collapse.

Sand consolidation is one of several methods used for controlling the production of formation sand and generally minimizing the harmfulness of down-hole particulates. The goal of particulate consolidation systems is to “consolidate” down-hole particulate material (e.g., formation sand, proppant, and other harvesting byproducts) around the well without appreciably decreasing the permeability of the rock. Typical sand consolidation systems use a liquid “treatment fluid that includes a carrier fluid or solvent, an epoxy, and other chemical components (e.g., a hardening agent, a foaming agent, a forming agent, a catalyst, and/or a buffer). In a sand consolidation process, the treatment fluid is combined and flushed into the formation, usually via the wellbore. In theory, the carrier solution moves the epoxy to the target zone, usually a 3-ft radius around the wellbore, and the epoxy consolidates the loose particulate material into a larger and preferably porous mass by attaching to or coating the individual particles or grains and then binding them together. If successful, the increase in compressive strength of the consolidated mass will be sufficient to withstand the drag forces of the wellbore fluids, allowing most of the formation material to remain intact and other particulates to remain on the well floor.

Although several different solvents can, and have been, used in consolidation systems, the cost and environmental impact of these solvents is a significant deterrent to consolidation systems that use these solvents. Aqueous based consolidation systems can be less expensive and have a reduced environmental impact; however, their stability and inconsistent results present a challenge to their use in manufacturing operations. A continuing need for a stable aqueous particulate consolidation system remains.

### SUMMARY OF THE DISCLOSURE

An aqueous solution containing a water soluble epoxy is disclosed. According to several exemplary embodiments, the aqueous solution is suitable for use as a treatment fluid in a process for consolidating particulate material. According to several exemplary embodiments, the aqueous solution is suitable for use as a treatment fluid in a process for consolidating down-hole particulate material in a hydrocarbon harvesting process.

Technical advantages of certain embodiments may include an aqueous solution that is homogenous, stable at surface temperatures, allows enhanced epoxy adsorption selectively at typical bottom-hole temperatures, encourages decreased sand production, and allows adsorption by silica surfaces. Other technical advantages will be readily apparent to one skilled in the art from the following descriptions and claims. Moreover, while specific advantages have been enumerated above, various embodiments may include all, some, or none of the enumerated advantages.

### DETAILED DESCRIPTION OF THE DISCLOSURE

Despite their cost and environmental advantages, aqueous based consolidation systems are not often successful due to problems with epoxy solubility and epoxy adsorption. For the purpose of this disclosure, epoxy solubility refers to the ability of the epoxy (solute) to dissolve in the solvent (treatment fluid or carrier solution) to form a solution. A solution is a liquid mixture in which the minor component (the epoxy) is uniformly distributed within the major component (the solvent or carrier fluid). Generally, an epoxy is soluble if it can form a homogenous solution in a temperature range that includes 70° F. (21° C.). Epoxies historically used in sand consolidation systems are not water soluble as defined above and therefore require solid suspension or liquid emulsion of the epoxy when an aqueous carrier solution is used. The heterogeneous nature of these solutions makes them are more likely to separate out or destabilize over time and less likely to yield repeatable consolidation, making them unreliable in manufacturing operations.

Moreover, even when the epoxy solubility is successfully addressed, epoxy adsorption often remains an issue in typical sand consolidation systems because the polar nature of the aqueous solvent repels the silica surfaces of the formation sand. When the epoxy is not successfully adsorbed, the epoxy is unable to coat the particulate material, making consolidation ineffective if not impossible. The teachings of this disclosure recognize an aqueous treatment fluid that is homogenous while still allowing epoxy adsorption that is needed for down-hole particulate consolidation systems. The following describes methods and compositions of a water soluble epoxy with enhanced adsorption at higher temperatures for providing these and other desired features.

The term “about” indicates a range which includes ±5% when used to describe a single number. When applied to a range, the term “about” indicates that the range includes −5% of a numerical lower boundary and +5% of an upper numerical boundary. For example, a range of from about 100° C. to about 200° C., includes a range of from 95° C. to 210° C. However, when the term “about” modifies a percentage, then the term means±1% of the number or numerical boundaries, unless the lower boundary is 0%. Thus, a range of 5-10%, includes 4-11%. A range of 0-5%, includes 0-6%.

Unless indicated otherwise, all measurements are expressed in metric units.

Unless indicated otherwise, the terms “a,” “an,” or “the” can refer to one or more than one of the noun they modify.

According to several exemplary embodiments, a fluid is provided, comprising:

an epoxy derivative of a polyethylene glycol, the polyethylene glycol having an average molar mass greater than 100 Daltons; and

an aqueous carrier solution;

wherein the epoxy is soluble in the aqueous carrier solution; and

wherein the fluid is suitable for use as a treatment fluid in a process for consolidating a particulate material in a subterranean formation.

According to several exemplary embodiments, the fluid includes an epoxy. A fluid is a substance that continually deforms or flows under an applied shear stress. Fluids are a subset of the phases of matter and include liquids, gases, plasmas, and some plastic solids. Unlike a liquid, the volume of a fluid is not independent of pressure.

An epoxy, is a class of reactive pre-polymers and polymers that contains an epoxide group (cyclic ether with a three-atom ring). Epoxies are highly reactive and used to cement or bond other particles. Often epoxide groups are included in larger chemical groups, such as glycidyl groups (an epoxide group with an ether linkage), a diglycidyl group (two glycidyl groups), or a diglycidyl ether (an oxygen atom connected to two glycidyl groups).

According to several exemplary embodiments, the fluid includes an epoxy that is an epoxy derivative of a polyethylene glycol (PEG) with a molar mass greater than 100 Daltons. According to several exemplary embodiments, an epoxy derivative of a polyethylene glycol is an epoxide group, created in a reaction involving polyethylene glycol. According to several exemplary embodiments, the epoxy derivative of a polyethylene glycol is a diglycidyl derivative of polyethylene glycol. According to several exemplary embodiments, a diglycidyl derivative of a polyethylene glycol is an epoxy with two glycidyl groups, created in a reaction involving polyethylene glycol. According to several exemplary embodiments, the epoxy derivative is diglycidyl ether.

Epoxy derivatives of polyethylene glycol can be manufactured or commercially purchased, however the molar mass of polyethylene glycol used must be greater than 100 Daltons or the solubility of the epoxy is decreased. Common examples of polymers that can react to form epoxy derivatives of polyethylene glycol include polyethylene glycol and polypropylene glycol, although any mixed polymer of polyethylene glycol and polypropylene glycol with a molar mass greater than 100 can be used. According to several exemplary embodiments, the epoxy was formed in a reaction of polyethylene glycol, polyethylene glycol and polypropylene glycol, or polyethylene glycol and another mixed polymer. Common examples of commercially available epoxy derivatives of polyethylene glycols include Epolight 40E, Epolight 200E, and Epolight 400E. These epoxies respectively include one, four, and nine monomer units of polyethylene glycol. Although the Epolight products are diglycidyl derivatives of polyethylene glycol, any epoxy derivative of polyethylene glycol may be used.

According to several exemplary embodiments, a fluid comprises an aqueous carrier solution. An aqueous carrier solution is one in which the solvent is water or the solvent is a solution that is substantially water (e.g., brine). According to several exemplary embodiments, an aqueous carrier solution is a carrier solution comprising 50% or more water by weight. According to several exemplary embodiments, a brine solution—such as a fluid including water and about 10.0% or less (by weight) of a potassium chloride (KCl), potassium sulfide (K₂SO₄), Sodium Chloride (NaCl), sodium sulfide (NaSO₄) salt, Calcium Chloride (CaCl₂), Magnesium Chloride (MgCl₂) or any combination of these salts—is an aqueous carrier solution.

A carrier solution is any fluid acting as a vehicle to transport and contain a chemical component (e.g., epoxy resin, one or more polymers, etc.) while the component is being transported into or within a subterranean formation. According to several exemplary embodiments, a carrier solution optionally chemically isolates the component until conditions are sufficient for a consolidation to occur, the solution reaches a desired temperature range, or a specific time period has expired. A carrier solution may have one or more additional purposes. For example, a carrier solution may be a hydraulic fracturing fluid, an acidizing fluid (acid fracturing, acid diverting fluid), a stimulation fluid, a sand control fluid, a completion fluid, a wellbore consolidation fluid, a remediation treatment fluid, a cementing fluid, a drilling fluid, a frac-packing fluid, or a gravel packing fluid. The carrier solution may be used in full-scale operations, pills, or any combination thereof. As used herein, a “pill” refers to a relatively small volume of a specially prepared treatment fluid placed or circulated in the wellbore.

According to several exemplary embodiments, the epoxy is soluble in the aqueous carrier solution. For the purposes of this disclosure, an epoxy is soluble in a solvent if the resulting solution is homogenous at about 70° F. (21° C.). For the purposes of this disclosure, solutions with liquid emulsions and/or solid suspensions are not homogenous solutions.

According to several exemplary embodiments, the epoxy derivative of polyethylene glycol is soluble in aqueous carrier solutions such as those described above. Without being bound by theory, it is believed that the solubility of epoxy derivatives of polyethylene glycol in aqueous solutions are temperature dependent due to hydrogen bonding of ether groups (i.e. a lone pair of electrons on an oxygen atom) with water molecules. Because hydrogen bonding decreases with increased temperature, it is expected and observed that epoxy derivatives of polyethylene glycol will be insoluble at higher temperatures. This temperature-based solubility is beneficial in consolidation systems because as the temperature increases, the epoxy separates from the aqueous solvent, and the polarity of the solvent is no longer an issue preventing epoxy adsorption by silica surfaces.

According to several exemplary embodiments, the fluid is suitable for use as a treatment fluid in a process for consolidating a particulate material in a subterranean formation. A treatment fluid is any fluid that interacts with a subterranean formation in a manner that ultimately increases oil or gas flow from the formation to the wellbore for removal to the surface. According to several exemplary embodiments, a treatment fluid reduces the amount of formation sand produced or inhibits the movement of down-hole particulates in the target zone. According to several exemplary embodiments, a treatment fluid is a combination of a carrier fluid or solvent, an epoxy, and other chemical components such as a hardening agent, a foaming agent, a forming agent, a catalyst, and/or a buffer. Hardening agents, foaming agents, forming agents, catalysts, and/or buffers are standard components of treatment fluids and may include any of several different chemicals well known to those of ordinary skill in the art. According to several exemplary embodiments, the treatment fluid includes from about 0.05% to about 30.0% of the epoxy by weight. According to several exemplary embodiments, the treatment fluid includes from about 1% to about 5.0% of the epoxy by weight. According to several exemplary embodiments, the treatment fluid includes from about 1.8% to about 2.8% of the epoxy by weight.

According to several exemplary embodiments, the treatment fluid may act as a vehicle that contains, and optionally chemically isolates, an epoxy resin and/or one or more polymers while being transported into the subterranean formation until the conditions are sufficient for a consolidation to occur. According to several exemplary embodiments, the treatment fluid may be used in full-scale operations, pills, or any combination thereof.

According to several exemplary embodiments, the treatment fluid is a homogenous solution at a temperature from about 35° F. (2° C.) to about 140° F. (60° C.). According to several exemplary embodiments, the treatment fluid is a homogenous solution at a temperature from about 50° F. (10° C.) to about 120° F. (49° C.). According to several exemplary embodiments, the treatment fluid is a homogenous solution at a temperature from about 60° F. (15° C.) to about 100° F. (38° C.).

According to several exemplary embodiments, particulate material is one or more particulates, particles, debris, hydrocarbon harvesting byproduct, or any combination thereof. According to several exemplary embodiments, particulate material is formation sand. According to several exemplary embodiments, a particulate material includes proppant, polymeric materials, precipitates, and/or byproducts from previous treatment fluids or processes and may include any solid object or objects in the wellbore or subterranean formation.

According to several exemplary embodiments, consolidating a particulate material refers to the forming, bonding, or chemical binding of one or more particulate materials into a mass. Examples of consolidation include, but are not limited to precipitation, amorphous gel formation, flocculation, coagulation, syneresis, aggregation, crystallization, coalescence, agglomeration, chemical binding, bonding, reacting, and/or combinations thereof. According to several exemplary embodiments, consolidation may prevent the particulates from settling before the fluid reaches the target treatment zone or zones. According to several exemplary embodiments, consolidation may occur in any desired treatment operation, such as, for example, drilling, reservoir stimulation, and cementing, among others. In some embodiments, the one or more masses are not extruded at any time during the treatment operation. In other words, according to several exemplary embodiments, the consolidated particulate material is consolidated out of the bulk of the treatment fluid in a manner that is effective to embed, entangle, and/or entrap the mass. According to several exemplary embodiments, consolidation occurs in a non-continuous manner (that is, a non-continuous process) or a continuous manner (that is, a continuous process), as desired. According to several exemplary embodiments, consolidation may occur downhole, such as before reaching the target treatment zone or at the target subterranean formation, but after the treatment fluid is placed or introduced into the wellbore.

According to several exemplary embodiments, a subterranean formation is an underground geologic formation that may or may not contain a reservoir and/or hydrocarbons such as oil and/or gas. According to several exemplary embodiments, consolidating a particulate material in a subterranean formation refers to consolidation occurring at one or more underground locations such as the wellbore, the subterranean formation, an underground location within the wellbore, within a certain distance or radius from the wellbore, and/or a target zone.

According to several exemplary embodiments, the amount of epoxy adsorbed by the particulate material is greater at temperatures greater than about 200° F. (93° C.) than the amount of epoxy adsorbed by the particulate material at temperatures less than 140° F. (60° C.). For the purposes of this disclosure, adsorption is the adhesion of atoms, ions, or molecules from a gas, liquid, or dissolved solid to a surface. A typical adsorption process creates a film of the adsorbate on the surface of the adsorbent. In a consolidation system, the liquid epoxy (adsorbate) creates a film on the surface of the particulate material (adsorbent). As the epoxy cures, the particulate material is consolidated into a mass. In sand consolidation systems, epoxy adsorption is often measured by a laboratory sand consolidation test. Sand consolidation tests are a standard comparison test that can be used to compare the effectiveness of sand consolidation systems. According to several exemplary embodiments, a sand consolidation test is used to measure epoxy adsorption.

According to several exemplary embodiments, a sand consolidation test includes packing a sand mixture in a modified core holder, pre-flushing the sand mixture with a brine solution to saturate the sand, measuring the sand for initial permeability, flushing the packed sleeve with a treatment fluid and curing the sleeve before it is measured for adsorption. According to several exemplary embodiments, adsorption is measured by comparing regained or percent regained permeability and unconfined compressive strength (UCS) for one or more sandpacks treated under one or more conditions. According to several exemplary embodiments, a first sandpack is said to have more epoxy adsorption than a second sandpack if the first sandpack has greater regained permeability, greater percent regained permeability, and/or greater UCS.

For the purposes of this disclosure, permeability is measured by pushing fluid through the packed sleeve at a constant fluid velocity (velocity_{fluid}) and measuring the pressure at the input (Pᵢₙₚᵤₜ) and output (Pₒᵤₜₚᵤₜ) of the sleeve. According to Darcy's Law, the Darcy coefficient of permeability (“permeability”) is the product of fluid velocity and sleeve length (lengthₛₗₑₑᵥₑ) divided by the pressure difference (Pₒᵤₜₚᵤₜ−Pᵢₙₚᵤₜ) or

$$Permeability = \frac{{velocity}_{fluid} \times {length}_{sleeve}}{{P}_{output} - {P}_{input}} .$$

Pₒᵤₜₚᵤₜ is sensitive to the amount of bonded sand. As the sand in the sleeve bonds, it becomes more difficult for liquids to move through the sleeve, trapping additional liquid within the sleeve. As the amount of trapped liquid increases, Pₒᵤₜₚᵤₜ increases while the other factors of the permeability equation remain approximately constant, resulting in a decrease in the measured permeability.

Often a comparison of initial and regained permeability is made by measuring permeability on the same sleeve, before and after treatment with a treatment fluid. The percent regained permeability is defined as

$$\frac{regained permeability}{initial permeability} \times 100 \%$$

and can indicate the effectiveness of a treatment method on sand bonding while accounting for minor differences in the pre-treated sand. Specifically, a lower percent regained permeability can indicate more bonded sand post treatment when comparing two treatment methods. When the amount of epoxy in the treatment fluids used, flow rate of the treatment fluid, and curing process post treatment is the same for multiple treatment methods, a comparison of percent regained permeability and regained permeability can indicate which treatment method allowed more epoxy adsorption by the particulate material.

Unconfined compressive strength (UCS) is measured by electromechanical compression systems. The UCS is an indicator of a sample's ability to absorb compressive stress and is sensitive to the amount of bonded sand. As with permeability, when the amount of epoxy, flow rate of the treatment fluids, and curing process is the same, a comparison of UCS between treatment samples can indicate which treatment method allowed more epoxy adsorption by the particulate material. Often, sandpack samples are split into two or three sections prior to UCS testing. When each section is tested individually, the uniformity of epoxy adsorption across the sample can be quantified.

According to several exemplary embodiments, a method is provided for placing at least some of a plurality of particulates in contact with an epoxy in an aqueous solution. According to several exemplary embodiments, the method includes:

introducing an aqueous treatment fluid into a subterranean formation, the subterranean formation comprising a plurality of particulates, and the aqueous treatment fluid comprising an epoxy; and

allowing at least some of the plurality of particulates to contact the epoxy;

wherein the epoxy comprises an epoxy derivative of polyethylene glycol; and

wherein at least some of the plurality of particulates consolidate after contact with the epoxy.

According to several exemplary embodiments, the method includes introducing an aqueous treatment fluid into a subterranean formation. According to several exemplary embodiments, an aqueous treatment fluid is a treatment fluid that uses water as a solvent or carrier fluid. According to several exemplary embodiments, an aqueous treatment fluid is a treatment fluid that uses an aqueous carrier solution as described above. According to several exemplary embodiments, the aqueous treatment fluid contains an epoxy. According to several exemplary embodiments, the epoxy comprises an epoxy derivative of polyethylene glycol. Descriptions of treatment fluids, carrier fluids, epoxies, epoxy derivatives of polyethylene glycol, diglycidyl derivatives, and other chemical components included above are incorporated herein by reference.

According to several exemplary embodiments, a subterranean formation is an underground geologic formation that may or may not contain a reservoir and/or hydrocarbons such as oil and/or gas. According to several exemplary embodiments, the subterranean formation includes a plurality of particulates. According to several exemplary embodiments, a plurality of particulates includes one or more particulates, particles, debris, proppant, polymeric materials, precipitates, and/or byproducts from previous treatment fluids or processes including hydrocarbon-harvesting byproducts. According to several exemplary embodiments, a plurality of particulates includes one or more particulate materials as described above. Descriptions of particulate material included above are incorporated herein by reference.

According to several exemplary embodiments, introducing a treatment fluid refers to the addition of the treatment fluid to a subterranean formation by any suitable means and, unless stated otherwise, does not imply any order by which the actions occur. Introducing the treatment fluid may be any method of pumping, flowing, or adding any fluid into the formation, by any of several means that are well known to those of ordinary skill in the art. According to several exemplary embodiments, introducing a treatment fluid customarily includes pumping the pre-mixed treatment fluid into the subterranean formation via the wellbore. According to several exemplary embodiments, components of the treatment fluid are pumped into the subterranean formation and then mixed downhole.

According to several exemplary embodiments, the method allows at least some of the plurality of particulates to contact the epoxy. The at least some of the plurality of particulates contacts the epoxy if the epoxy attaches to or coats one or more particulates of the plurality of particulates. According to several exemplary embodiments, contact between the epoxy and the plurality of particulates is the first step in a consolidation process. According to several exemplary embodiments, at least some of the plurality of particulates consolidate after contact with the epoxy. Descriptions of consolidation included above are incorporated herein by reference.

The following examples are illustrative of the compositions and methods discussed above and are not intended to be limiting.

Sand Consolidation Testing

To evaluate the effectiveness of an epoxy derivative of polyethylene glycol, qualitative experiments were performed on sandpacks treated with an identical treatment fluid at two different processing temperatures.

The treatment fluid used was prepared by modifying a standard treatment fluid used in sand consolidation in the following manner. To prepare the treatment fluid, 269 mL of filtered KCl brine, 18 mL of SandTrap ABC service Part B (FDP-S1001B-10), 1.5 mL of SandTrap ABC service Part C (FDP-S1001C-10) were added and combined to create a solution. In this solution, the KCl brine used was a pre-made solution of approximately 7% KCl salt by weight and filtered water. SandTrap ABC is a commercially available, heterogeneous, aqueous fluid that includes an epoxy resin (service Part A), a hardening agent (service Part B) and a foaming agent (service Part C), however service Part A was not used. After the brine and SandTrap components were added and mixed, the pH of the solution was measured and determined to be about 10. Next, an organic buffer, BA-20, was added until the pH was measured to be about 8.0. BA-20 is a commercially available organic acid containing acetic acid and ammonium acetate. Finally, 8.4 mL of an epoxy, Epolight 200E, and 3 mL of a forming agent, HC-2, were added to the solution. Epolight 200E is an epoxy derivative of a polyethylene glycol with a molar mass of about 200 Daltons. HC-2 is a surfactant additive containing inner salt of alkyl amines and sodium chloride. In total, approximately 300 mL of a homogenous treatment fluid was created. The composition of the treatment fluid is shown in Table 1.

Table 1 lists the name, amount in mL, and function of the components of the treatment fluid.

TABLE 1
Treatment Fluid Composition

| Component | Amount | | Function |
|---|---|---|---|
| KCI Brine | 269 | mL | Aqueous Carrier Fluid |
| FDP-S1000B-10 | 18 | mL | Hardening Agent |
| FDP-S1000C-10 | 1.5 | mL | Foaming |
| BA-20 | To decrease pH to 8.0 | | Buffer |
| HC-2 | 3 | mL | Forming Agent |
| Epolight 200 E | 8.4 | mL | Epoxy |

The composition of the sand used in the sandpacks was 85 grams of SSA-2, 13 grams of microsand, and 2 grams of bentonite clay. SSA-2 is silica particles having particle sizes from about 0.125 mm to about 0.250 mm (reported as 120 mesh size to 60 mesh size). Microsand is finely ground silica with particle sizes of about 0.005 mm. After the sand was mixed, the mixture was packed in modified Hassler sleeves to a maximum length of 95 mm, heated to the processing temperature (140° F. or 200° F.) by an external heating jacket, saturated with 7% KCl brine solution, allowed to stabilize for one hour, and then measured for initial permeability. After initial permeability was measured, the sandpacks were treated at process temperature with approximately 132 mL (measured as 6 pore volumes) of the treatment fluid described in Table 1 at a rate of 5 mL/minute, a backpressure of 100 psi, and a confined pressure of 350 psi; and then cured at 200° F. (93° C.) for 25 hours. The treatment fluid was preheated to the process temperature and no post flush was used. After completion of the curing period, the regained permeability of the cured sandpacks was measured. The sandpacks were then removed from the modified Hassler packs and sectioned into “top,” “middle,” and “bottom” pieces. The pieces were measured for UCS using an automatic compression-testing machine, “Complete Full Automatic Compression Testing Machine” by Shangai Huolog Test Instrument Company, Ltd.

The results of the tests are provided below in Table 2 and show that the sandpack treated at 200° F. (93° C.) likely adsorbed more epoxy than the sandpack treated at 140° F. (60° C.).

TABLE 2
Epoxy Adsorption Results

| | | Unconfined | | | |
|---|---|---|---|---|---|
| | | Compressive | | | |
| | | Strength | Initial | Regained | Percent |
| Test | Treatment | top:middle:bottom | Permeability | Permeability | Regained |
| Number | Temperature | (psi) | (milli-Darcy) | (milli-Darcy) | Permeability |
| 1 | 200° F.(93° C.) | 208-431-77 | 253 mD | 122 mD | 48% |
| 2 | 140° F.(60° C.) | 106-91-29 | 234 mD | 226 mD | 96% |

As shown in Table 2, the sandpack treated at 200° F. (93° C.) had a UCS of 280, 431, 77 psi when measured, respectively, at the top, middle, bottom of the sandpack. The sandpack treated at 140° F. (60° C.) had a UCS of 106, 91, 29 psi when measured, respectively, at the top, middle, bottom of the sandpack. Because all other experimental factors were consistent between the two sandpacks, these results indicate that the sandpack treated at 200° F. (93° C.) adsorbed more epoxy resin. Moreover, the regained permeability of the sandpack treated at 140° F. (60° C.) was 96% of the initial permeability, whereas the regained permeability of the sandpack treated at 200° F. (93° C.) was 48% of the initial permeability. The lower regained permeability also indicates increased epoxy adsorption by the sandpack treated at 200° F. (93° C.). Thus, the experimental results indicate the epoxy adsorption and sand bonding of sandpacks treated with a homogenous treatment fluid containing a water-soluble epoxy derivative of polyethylene glycol is likely enhanced at higher temperatures.

Accordingly, it is expected that a treatment fluid containing an epoxy derivative of polyethylene glycol will be homogeneous and highly stable at surface conditions, but will have increased sand adsorption and sand bonding at higher temperatures—such as those at the bottom of wellbore—allowing specific epoxy adsorption at the target zone. Because conventional aqueous based sand consolidation systems are heterogeneous mixtures that use solid suspensions or liquid emulsions of insoluble epoxy resins, they are subject to complications like destabilization and non-repeatable performances. Thus, treatment fluids with an epoxy derivative of polyethylene glycol are advantageous over the current heterogeneous water based sand consolidation systems due to their high solubility at surface temperatures and enhanced epoxy adsorption at temperatures in the target zone.

1. A fluid, comprising:
an epoxy derivative of a polyethylene glycol, the polyethylene glycol having an average molar mass greater than 100 Daltons; and
an aqueous carrier solution;
wherein the epoxy derivative is soluble in the aqueous carrier solution; and
wherein the fluid is suitable for use as a treatment fluid in a process for consolidating a particulate material in a subterranean formation.

2. The fluid of claim 1, wherein the epoxy derivative of a polyethylene glycol is a diglycidyl derivative of polyethylene glycol.

3. The fluid of claim 1, wherein the subterranean formation includes a wellbore and the particulate material is a by-product of a process for harvesting hydrocarbons from the subterranean formation.

4. A fluid, comprising:
an epoxy derivative of a polyethylene glycol;
wherein the fluid is an aqueous solution suitable for use as a treatment fluid in a process for consolidating a particulate material.

5. The fluid of claim 4, wherein the epoxy derivative of a polyethylene glycol is a diglycidyl derivative of polyethylene glycol.

6. The fluid of claim 5, wherein the diglycidyl derivative of polyethylene glycol is selected from a diglycidyl derivative of a polyethylene glycol with a molar mass greater than about 100 Daltons, a diglycidyl derivative of a polyethylene glycol with a molar mass from about 100 Daltons to about 5000 Daltons, and a diglycidyl derivative of a mixed polymer of polyethylene glycol and polypropylene glycol.

7. The fluid of claim 4, wherein the particulate material is a by-product of a process for harvesting hydrocarbons from a subterranean formation.

8. The fluid of claim 4,
wherein the particulate material is a by-product of a process for harvesting hydrocarbons from a subterranean formation; and
wherein the subterranean formation includes a wellbore.

9. The fluid of claim 4, wherein the fluid comprises an amount of the epoxy derivative selected from about 0.05% to about 30.0% by weight, about 1% to about 5.0% by weight, and about 1.8% to about 2.8% by weight.

10. The fluid of claim 4, wherein the fluid is a homogenous solution at a temperature range selected from about 35° F. to about 140° F., about 50° F. to about 120° F., and about 60° F. to about 100° F.

11. (canceled)

12. A method, comprising:
introducing an aqueous treatment fluid into a subterranean formation, the subterranean formation comprising a plurality of particulates, and the aqueous treatment fluid comprising an epoxy; and
allowing at least some of the plurality of particulates to contact the epoxy;
wherein the epoxy comprises an epoxy derivative of a polyethylene glycol; and
wherein at least some of the plurality of particulates consolidate after contact with the epoxy.

13. (canceled)

14. The method of claim 12, wherein the epoxy derivative of a polyethylene glycol is a diglycidyl derivative of polyethylene glycol.

15. The method of claim 14, wherein the diglycidyl derivative of polyethylene glycol is selected from a diglycidyl derivative of a polyethylene glycol with a molar mass greater than 100 Daltons, a diglycidyl derivative of a polyethylene glycol with a molar mass between about 100 Daltons and about 5000 Daltons, and a diglycidyl derivative of a mixed polymer of polyethylene glycol and a polypropylene glycol.

16. The method of claim 12, wherein the aqueous treatment fluid is homogenous at a temperature range selected from about 35° F. to about 140° F., about 50° F. to about 120° F., and about 60° F. to about 100° F.

17. The method of claim 12, further comprising:
adsorption of the epoxy by the at least some of the plurality of particulates;
wherein the amount of epoxy adsorbed by the at least some of the plurality of particulates is greater at temperatures greater than about 200° F. than the amount of epoxy adsorbed by the at least some of the plurality of particulates at temperatures less than 140° F.

18. The method of claim 12,
wherein the plurality of particulates is a by-product of a process for harvesting hydrocarbons from a subterranean formation; and
wherein the method consolidates from about 50% to about 100% of the plurality of particulates within about 0 meters to about 1 meter of the wellbore.

19. The method of claim 12 wherein the aqueous treatment fluid comprises an amount of the epoxy selected from about 0.05% to about 30.0% by weight, about 1% to about 5.0% by weight, and about 1.8% to about 2.8% by weight.

20. The fluid of claim 1, wherein the fluid comprises an amount of the epoxy derivative selected from about 0.05% to about 30.0% by weight, about 1% to about 5.0% by weight, and about 1.8% to about 2.8% by weight.

21. The fluid of claim 1, wherein the fluid is a homogenous solution at a temperature range selected from about 35° F. to about 140° F., about 50° F. to about 120° F., and about 60° F. to about 100° F.
